(19) United States
(12) Patent Application Publication
(10) Pub. No.: US 2026/0091763 A1
(43) Pub. Date: Apr. 2, 2026

(54) AUTONOMOUS REFILLING BASE FOR AGRICULTURAL ROBOTS WITH MULTIPLE MAINTENANCE AND REFUEL FUNCTIONS

(71) Applicant: TECSOIL AUTOMAÇÃO E SISTEMAS S.A., Araçatuba (BR)

(72) Inventors: Victor Mejias Lopez, Araçatuba (BR); Brady Gick, Lafayette, IN (US); Kyle Gick, Lafayette, IN (US); Deulis Antonio Pelegrin Jaime, Araçatuba (BR); Thiago Santana Aranha, Araçatuba (BR)

(73) Assignee: TECSOIL AUTOMAÇÃO E SISTEMAS S.A., Araçatuba (BR)

(21) Appl. No.: 19/348,391

(22) Filed: Oct. 2, 2025

(30) Foreign Application Priority Data
Oct. 2, 2024 (BR) 102024020453-0

(51) Int. Cl. B60S 5/02; A01B 69/00; B60S 3/04; G05D 1/225; G05D 1/248; G05D 1/249; G05D 1/661; G05D 111/30; G05D 111/60

(52) U.S. Cl. CPC B60S 5/02; B60S 3/04; G05D 1/225; G05D 1/248; G05D 1/249; G05D 1/661; A01B 69/004; G05D 2111/32; G05D 2111/60

(57) ABSTRACT

The present invention relates to an autonomous refilling base for agricultural robots, designed to increase their autonomy and enable continuous operation without human intervention. The base uses an automatic camera-guided navigation system to connect to the robot and perform maintenance and supplying. It has tanks for storing various products, such as herbicides and insecticides, and decontaminates the robot and its pipes. With solar panels and batteries, the base is energetically self-sufficient and equipped with RTK GPS, and an internet connection, ensuring precise operation and real-time synchronization.

### FIELD OF THE INVENTION

The present invention falls within the technological field of precision agriculture and agricultural robotics. More specifically, the invention applies to automated maintenance and refuel systems for agricultural robots, enabling continuous field operations with minimal human intervention.

### BACKGROUND OF THE PRIOR ART

Currently, precision agriculture uses a range of autonomous equipment and vehicles to distribute agricultural inputs such as fertilizers, pesticides, herbicides, and seeds. Refilling these inputs still largely depends on significant human intervention. There are solutions on the market that allow for partial automation of refilling, but these systems typically require the operator to manually position the machine in the correct location and are limited to specific functions, such as electric recharging or supplying a single type of product.

Autonomous agricultural vehicles, such as tractors, drones, and robots, are already widely used for spraying, seeding, and crop monitoring. Some of these vehicles have advanced GPS navigation systems and sensors that allow them to operate precisely and optimally over large areas. However, refilling these vehicles' input remains a challenge, as they often need to interrupt operations to return to their refiling base, or an operator must manually refill them.

Additionally, there is a limitation to a single product type, with no flexibility to switch between different products as needed.

There is also a lack of automated decontamination systems for the pipes and the robot itself, increasing the risk of cross-contamination. This is in addition to the heavy reliance on external power sources for continuous operation.

Given the difficulties present in the prior art mentioned above, the present invention offers an innovative solution to the aforementioned problems by providing an autonomous refilling base capable of operating without human intervention, performing various maintenance and supplying functions. Furthermore, the base is equipped with a solar energy capture system, ensuring its energy autonomy.

### OBJECTIVE OF THE INVENTION

It is an objective of the present invention to provide an autonomous input refilling base capable of performing various maintenance and supplying functions, capable of operating without human intervention and which has an energy self-sufficiency system using a solar energy capture system and batteries.

### SUMMARY OF THE INVENTION

The present invention describes an autonomous refilling base designed to increase the autonomy of agricultural robots, allowing them to operate for several days without human intervention. The base uses a navigation and automatic connection system, guiding the robot through cameras to perform the necessary alignment for the hydraulic connection. After connection, the base performs several maintenance and supplying functions, including providing different products and decontaminating the robot and its own pipes, preventing cross-contamination. The invention is equipped with multiple tanks for storing different products, allowing for switching between, for example, herbicides and insecticides. Although the tanks are refilled manually, the base offers high autonomy thanks to its large storage volume and ability to maintain homogeneous mixtures. Furthermore, the base is energy-independent, operating through solar panels and batteries, and is equipped with RTK GPS and an internet connection, ensuring its precise location and real-time synchronization with the robot.

### BRIEF DESCRIPTION OF THE DRAWINGS

The present invention will be described in more detail below, with reference to the attached figures which, in a schematic manner and not limiting the inventive scope, represent examples of its embodiment. The drawings showing:

FIG. 1 illustrates the autonomous refilling base for agricultural robots with multiple maintenance and supplying functions;

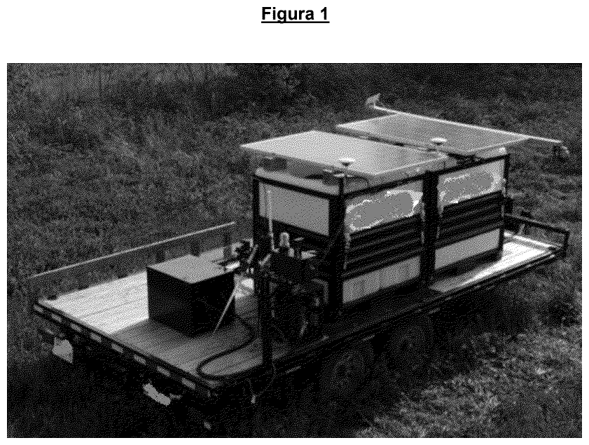

FIG. 2 illustrates the base and robot approaching for connection and refilling;

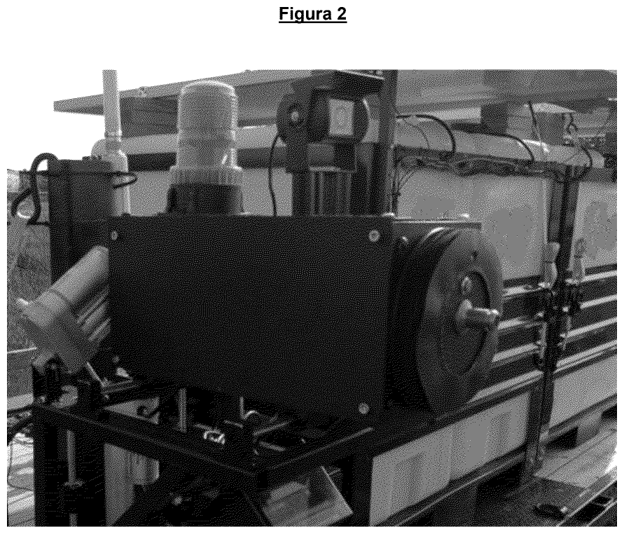

FIG. 3 illustrates the base connection system; and

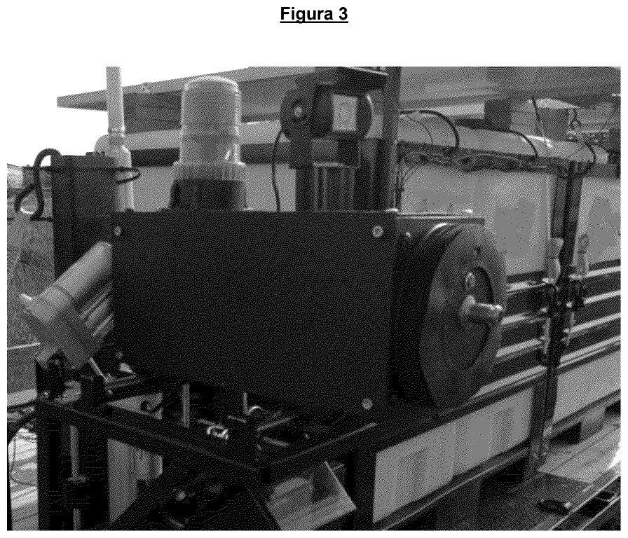

FIG. 4 illustrates the camera connection and alignment system on the robot.

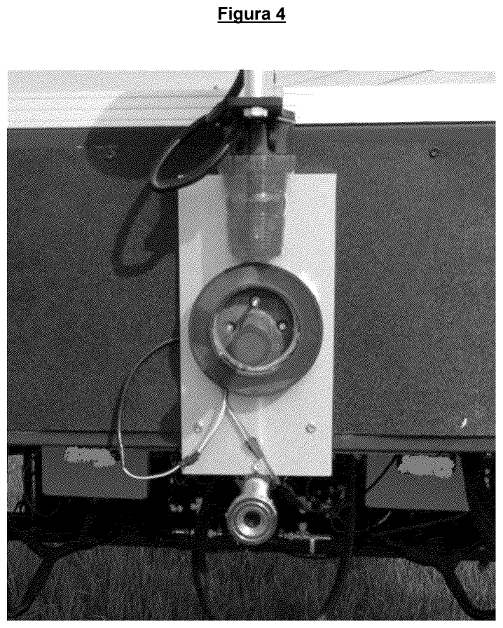

### DETAILED DESCRIPTION OF THE INVENTION

Below is a detailed description of a preferred embodiment of the present invention, which is exemplary and in no way limiting. However, possible additional embodiments of the present invention, still encompassed by the essential and optional features below, will become clear to one skilled in the art upon reading this description.

The autonomous refilling base for agricultural robots with multiple maintenance and refueling functions was developed to increase the operational autonomy of agricultural robots, allowing them to perform their activities in the field for long periods without the need for human intervention. This base combines multiple essential functions for robot maintenance, refueling, and decontamination, in addition to featuring a self-sufficient power generation system using solar panels and batteries.

The proposed solution is equipped with an automatic navigation system that enables precise connection between the robot and the base without manual intervention. As the robot approaches the base, it uses camera views to identify and guide the robot to the exact connection position. The process is performed autonomously, with the base guiding the robot to align itself in reverse, enabling the hydraulic connection necessary for refueling and other maintenance operations.

Once the connection is established, the base can perform several critical robot maintenance and support functions, including:
Product Supply: The base can carry different products needed for the robot's agricultural operations, such as herbicides, insecticides, or fertilizers.
Product Removal and Replacement: If necessary, the base can remove residual products from robot systems before loading new products.
Decontaminant circulation: One of the base tanks is reserved for the circulation of water or decontaminants, ensuring the cleanliness of the pipes and avoiding cross-contamination between the different products used.

The base is designed to handle multiple products efficiently and flexibly. It can contain two or more tanks, one dedicated to water or decontaminant and others for specific products used in the field, such as herbicides or insecticides. This flexibility allows the base to easily switch between different products, adapting to the specific needs of the crops. For example, it can operate with herbicides during the day and insecticides at night, or even in adjacent areas that require different products.

An important aspect of the invention is the decontamination system, which prevents cross-contamination between products used in the robot. Using the decontamination tank, the base can circulate the product through all its internal piping, as well as through the robot's systems, ensuring that the lines are always clean before loading new products.

Despite being an autonomous base, refilling the tanks with new products still requires manual operation. However, the tanks have a large capacity, providing high autonomy and reducing the frequency of interventions. Furthermore, the base maintains homogeneous product mixtures, preventing sedimentation or phase separation. It is worth noting that the initial mixing of the products is not done by the base; the solution must already be prepared upon insertion.

The autonomous refilling base is equipped with solar panels, ensuring its operation without the need for external power sources. The energy captured by the solar panels is stored in batteries, allowing the base to operate continuously, even during periods of low sunlight. This renewable energy generation system increases the efficiency and sustainability of the operation.

The base uses an RTK (Real-Time Kinematic) GPS system to ensure its precise location in the field, allowing the agricultural robot to locate it accurately. Furthermore, the base is connected to the internet via cellular networks, enabling real-time information exchange with robot and other systems, ensuring synchronized operations and remote monitoring of the base.

The base has the following operational benefits:
Reduced human intervention: The base allows agricultural robots to operate autonomously for several days, performing refilling and maintenance without the need for constant supervision.
Efficient product changeover: The ability to change products quickly and without contamination allows for greater flexibility and efficiency in agricultural operations.
Energy sustainability: The use of solar energy ensures that the base operates self-sufficiently, without relying on external and temporary energy sources.
High autonomy: With large-volume tanks and efficient maintenance systems, the base can operate for long periods before needing refueling.

This invention represents a significant advance in the field of agricultural automation, providing a robust and autonomous solution for supporting robots in the field, with high operational efficiency and minimal human intervention.

It should be noted that the embodiments described herein in the present specification are intended to clarify and provide sufficient descriptiveness for the invention, however the scope of protection of the invention is delimited by the claims.

1. AN AUTONOMOUS REFILLING BASE FOR AGRICULTURAL ROBOTS comprising:
a navigation system;
a maintenance system;
a supplying system;
a decontamination system; and
an autonomous refilling system.

2. THE AUTONOMOUS REFILLING BASE, according to claim 1, characterized in that the navigation system has at least two camera views to identify and guide the robot to the connection position.

3. THE AUTONOMOUS REFILLING BASE, according to claim 2, characterized in that the navigation system guides the robot to align itself in reverse to perform the hydraulic connection for supplying and other maintenance operations.

4. THE AUTONOMOUS REFILLING BASE, according to claim 1, characterized in that the navigation system is GPS RTK (Real-Time Kinematic) to ensure its precise location and synchronization with the robot in real time.

5. THE AUTONOMOUS REFILLING BASE, according to claim 1, characterized in that the navigation system also comprises an internet connection via cellular networks to enable the real-time information exchange of with robot and other systems, ensuring the synchronization of operations and remote monitoring of the base.

6. THE AUTONOMOUS REFILLING BASE, according to claim 1, characterized in that it is equipped with multiple tanks for the maintenance, refuel and decontamination of robots.

7. THE AUTONOMOUS REFILLING BASE, according to claim 1, characterized in that the decontamination system has a decontaminant tank to circulate the product through all its internal pipes, as well as through robot systems.

8. THE AUTONOMOUS REFILLING BASE, according to claim 7, characterized in that the decontaminating product is water or a decontaminant.

9. THE AUTONOMOUS REFILLING BASE, according to claim 1, characterized in that the autonomous refilling system has at least two solar panels, in which the energy captured by the solar panels is stored in batteries.
